(19) United States
(12) Patent Application Publication
(10) Pub. No.: US 2026/0050981 A1
(43) Pub. Date: Feb. 19, 2026

(54) SYSTEM

(71) Applicant: SOFTBANK GROUP CORP., Tokyo (JP)

(72) Inventor: Mikio YAGI, Tokyo (JP)

(73) Assignee: SOFTBANK GROUP CORP., Tokyo (JP)

(21) Appl. No.: 19/299,630

(22) Filed: Aug. 14, 2025

(30) Foreign Application Priority Data
Aug. 16, 2024 (JP) 2024-137298

(51) Int. Cl. G06Q 40/06

(52) U.S. Cl. CPC G06Q 40/06

(57) ABSTRACT

A system includes a processor that is configured to collect energy consumption data and CO2 emission data in real time by an IoT terminal, store and preprocess the received data on a cloud server, analyze the preprocessed data and generate a renewable energy investment proposal by a generative AI, and generate an investment proposal report and provide said report to a user.

### CROSS-REFERENCE TO RELATED APPLICATION

This application is based on and claims priority under 35 USC 119 from Japanese Patent Application No. 2024-137298 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for energy management in enterprises face several challenges, including a lack of real-time data collection on energy consumption and CO2 emissions, insufficient data integrity and abnormality correction mechanisms, limited ability to generate optimized investment proposals for renewable energy systems, and inadequate tools for monitoring the effectiveness of installed renewable energy solutions and providing feedback. These shortcomings hinder enterprises from effectively improving energy efficiency and achieving CO2 emission reductions in a timely and data-driven manner.

### SUMMARY

The present invention provides a system comprising a processor configured to collect energy consumption data and CO2 emission data in real time using IoT terminals, store and preprocess the received data on a cloud server, analyze the preprocessed data and generate renewable energy investment proposals using a generative AI, and generate and provide investment proposal reports to users. The processor is further configured to verify the integrity of the collected data and correct abnormal values, and also to monitor post-installation performance of renewable energy systems and provide feedback. This comprehensive approach enables enterprises to improve energy management operations, optimize investment in renewable energy, and continuously reduce CO2 emissions based on reliable and timely data analytics.

“IoT terminal” means a device equipped with sensors and communication functions for collecting and transmitting various types of data, such as energy consumption and CO2 emissions, from physical environments in real time.

“Energy consumption data” means measurement information representing the amount of energy used by a facility or equipment, typically including electricity, gas, or other utility usage values.
“CO2 emission data” means numerical information indicating the quantity of carbon dioxide released into the atmosphere as a result of energy consumption or other industrial activities.
“Cloud server” means a remote computing system or platform accessible over a network, which provides data-storage, processing, and analysis services.
“Preprocessing” means data operations performed to verify the integrity, correct errors or abnormalities, supplement missing values, and prepare the data for further analysis.
“Generative AI” means an artificial intelligence model capable of analyzing input data and autonomously generating outputs such as predictions, recommendations, or proposals, based on learned patterns.
“Renewable energy investment proposal” means an analysis result or recommendation specifying the optimal renewable energy systems or resources to be introduced, along with cost estimations, payback periods, and expected effects.
“Investment proposal report” means a compiled document or data file that presents the analysis results, recommended actions, costings, predicted benefits, and other relevant insights for user review.
“User” means an individual or entity authorized to access, review, and act upon the information and recommendations generated by the system.
“Performance monitoring” means the process of continuously or periodically measuring and evaluating the operational status, output, and efficiency of installed equipment, such as renewable energy systems.
“Feedback” means actionable information or recommendations provided to the user based on the evaluation of system performance or the analysis of ongoing data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

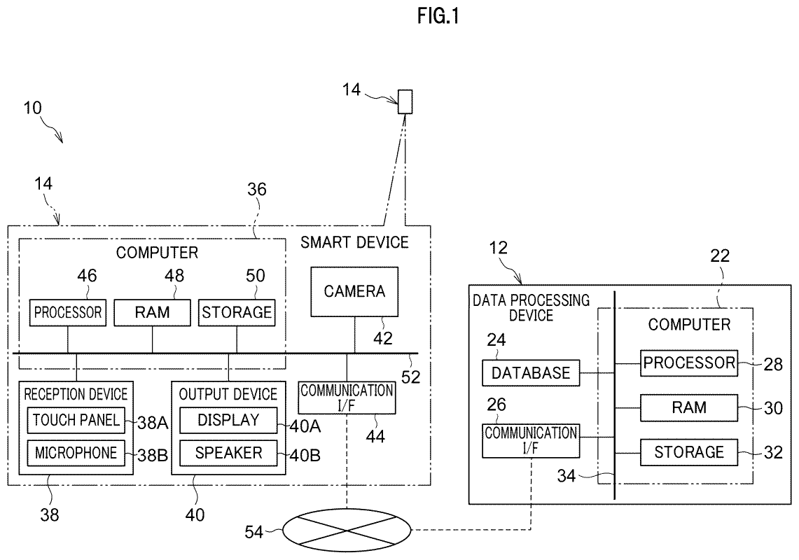

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

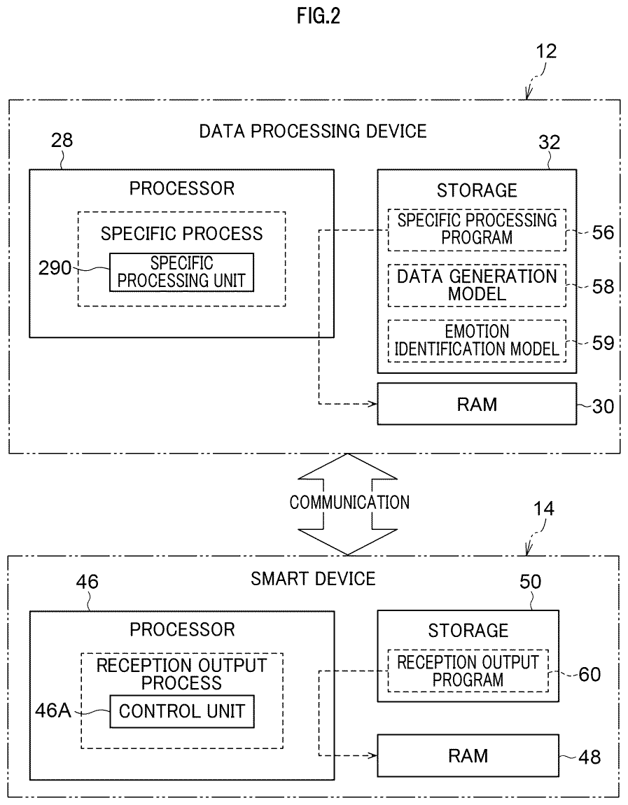

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent years, businesses and facility operators have faced increasing pressure to optimize energy consumption and reduce greenhouse gas emissions. However, there is a lack of effective tools or systems that can collect a wide range of real-time environmental data, process and analyze the data for inconsistencies or anomalies, and generate concrete, data-driven proposals for renewable energy investment. It is further difficult to monitor the effectiveness of such investments after deployment and provide actionable feedback for ongoing improvement. Moreover, conventional systems lack advanced capabilities to utilize generative artificial intelligence models for deep analysis and customized recommendation generation using up-to-date environmental and technological trends.

The specific processing by the specific processing unit 290 of the data processing device 12 in Example 1 is realized by the following means.

The present invention provides a server comprising a processor configured to collect a plurality of types of environmental-related data from measuring devices in real time, store the received data in a structured database with periodic backups, verify and correct data integrity and anomalies, aggregate and preprocess the data, generate and send prompt sentences to a generative artificial intelligence model, obtain optimization plans including equipment installation proposals based on the model's analysis, rank and generate proposal documents based on evaluation indices, and provide such proposal documents to users through a user interface via a network. This enables comprehensive, real-time data-driven environmental management, supports optimal renewable energy investment decision-making, and facilitates ongoing monitoring and improvement using generative artificial intelligence technology.

The term “processor” refers to a physical or virtual computing unit configured to perform data collection, storage, analysis, generation of output, and user interfacing tasks as described in the claims.

The term “measuring device” refers to any hardware sensor, meter, or detection equipment capable of capturing environmental-related data such as power consumption, gas usage, or emission quantities in real time.
The term “environmental-related data” refers to information measured or calculated concerning energy usage, resource consumption, pollutant output, and other indicators relevant to environmental monitoring.
The term “structured database” refers to a data storage system that organizes information into defined formats, such as tables or records, allowing for efficient search, retrieval, and data management.
The term “data integrity verification” refers to processes and algorithms used to ensure that data are consistent, accurate, and free from contradiction or corruption.
The term “anomaly correction” refers to procedures for detecting and amending abnormally high, low, or out-of-range values within a dataset, often applying statistical or logical checks.
The term “prompt sentence” refers to a structured textual input generated for submission to a generative artificial intelligence model, typically summarizing preprocessed data and specifying the analysis or recommendation tasks to be performed.
The term “generative artificial intelligence model” refers to a machine learning architecture capable of producing analytical or synthetic outputs-including natural language and structured recommendations-based on input data or instructions.
The term “optimization plan” refers to an output that proposes resource allocation, system configuration, or equipment installation strategies aimed at improving environmental or operational performance.
The term “equipment installation plan” refers to a component of the optimization plan detailing the type, scale, and implementation strategy for deploying specific devices, apparatuses, or systems.
The term “evaluation index” refers to a quantifiable metric or set of criteria used to assess, rank, or compare multiple plans, including investment effect, payback period, efficiency improvement, and emission reduction.
The term “proposal document” refers to a report or file generated based on analytical results and optimization plans, formatted according to predetermined standards, and provided to users for review and decision-making.
The term “user interface” refers to any graphical, textual, or interactive module that allows an end-user to access, review, and manage information or proposals generated by the system via a network.
The term “network” refers to a communication infrastructure, such as the Internet or a local-area network, enabling data exchange between system components and users.

The invention can be embodied in a system comprising a server (processor), one or more terminals (measuring devices), and a user interface connected via a network. The following is a detailed description of the configuration and implementation of the invention, which supports the claims and enables others skilled in the art to practice the invention.

The terminal is implemented as a measuring device, such as a smart meter or environmental sensor, capable of collecting various types of environmental-related data in real time. For example, the terminal may include a smart electricity meter, a gas meter, and a carbon dioxide (CO2) sensor. Specific hardware options include universal IoT gateway devices and standard environmental parameter sensors. The terminal continuously collects data such as electricity consumption, gas usage, and CO2 emission levels and transmits the acquired data to the server at regular intervals over a communication network using a protocol such as MQTT or HTTP. The server is realized with a data processor such as a general-purpose computer, a virtual machine, or a cloud server instance. The server incorporates a data storage subsystem, which may utilize a structured database such as a relational database management system. Examples of appropriate database management software include Amazon RDS or Google BigQuery. The server receives data from the terminal, stores it in the database, and creates scheduled backups to maintain data durability.
The server is configured to conduct data integrity verification and anomaly correction. The server uses data processing algorithms, implemented for example using SQL, Python's pandas library, or equivalent tools, to detect inconsistencies such as duplicate timestamps, missing values, or physically impossible values in the stored environmental data. Upon detecting anomalies, the server automatically corrects or fills the defective records using statistical techniques such as linear interpolation or median imputation.
Once data integrity is assured, the server aggregates and preprocesses the environmental-related data, organizing it into time-series datasets for further analysis. The server generates a prompt sentence summarizing the data and submits this input to a generative AI model, such as GPT-4 or any equivalent generative artificial intelligence model, using an API. The prompt sentence typically contains relevant consumption information and a request for analysis or recommendation.
For example, the server may generate and use the following prompt sentence:
“Based on Company X's energy consumption and CO2 emissions data, please generate the optimal renewable energy investment proposal. The monthly average electricity consumption is 100,000 kWh, monthly average gas consumption is 20,000 m3, and the annual total CO2 emissions are 2,400 tons. Please take into account the latest renewable energy technology trends and incentives.”
The generative AI model analyzes the input prompt, identifies consumption and emission trends, and produces an optimization plan that may include equipment installation proposals for renewable energy systems such as photovoltaic modules or wind turbines. The optimization plan includes ranked recommendations based on evaluation indices such as investment effect, payback period, efficiency improvement estimate, and emission reduction estimate.
The server, using an investment plan management function, ranks the equipment installation proposals according to these indices, then generates a proposal document in a standardized format. The proposal document contains detailed recommendations, quantitative analysis, charts, and supporting information for user review.
The user, via a web-based user interface or dedicated application, logs into the system, views and downloads proposal documents, and utilizes the provided analysis to make informed decisions regarding environmental management strategies and equipment installation.
As a concrete example, a manufacturing company may deploy terminals throughout its facility to collect real-time data on energy consumption and emissions. The server processes, analyzes, and summarizes this data, requests scenario analysis from the generative AI model using a tailored prompt sentence as described above, and presents an actionable, prioritized investment plan through the user interface for decision-making.
Thus, this invention enables comprehensive, automated, and efficient environmental data collection, processing, analysis, and proposal generation, supporting optimal planning and implementation of environmental improvement measures by leveraging real-time data and state-of-the-art generative artificial intelligence technologies.

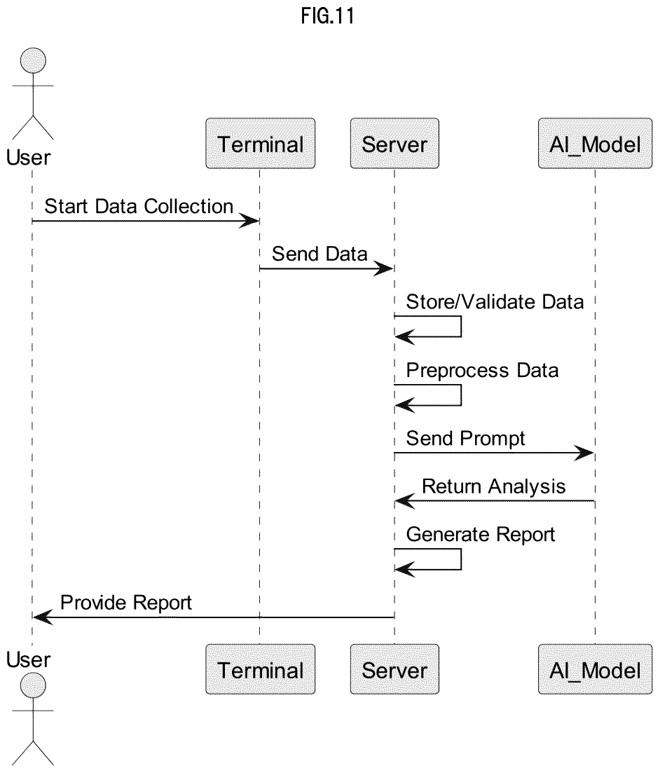

The following describes the processing flow using FIG. 11.

### Step 1

The terminal collects real-time environmental-related data, such as electricity consumption, gas usage, and CO2 emissions, using sensors or meters installed in a facility. The input is raw measurement readings obtained every minute. The terminal processes the sensor signals to create timestamped data records, and temporarily stores these records in internal memory. The output is structured data packets ready for transmission.

### Step 2

The terminal transmits collected data packets to the server via a network using a communication protocol such as MQTT or HTTP at regular intervals. The input is the data packets structured in Step 1. The terminal monitors the connection, retries transmission if errors occur, and marks sent data as delivered upon acknowledgment. The output is the reception of structured environmental-related data by the server.

### Step 3

The server receives incoming data from the terminal and stores it in a structured database, such as a relational database management system. The input is the structured data packets received via the network. The server parses the received data, verifies its format, and inserts valid records into the database while logging errors for incomplete transmissions. The output is a growing repository of time-stamped and device-tagged environmental-related data.

### Step 4

The server verifies data integrity and performs anomaly correction on the stored data. The input is data retrieved from the structured database. The server checks for missing values, duplicate timestamps, or out-of-range measurements by running data validation queries and using algorithms such as linear interpolation for missing values and median filtering for anomalies. The output is a cleansed and consistent environmental-related dataset.

### Step 5

The server aggregates and preprocesses the cleaned data to prepare it for analysis. The input is the verified and corrected data from Step 4. The server compiles daily, weekly, or monthly summaries, calculates statistics such as averages and peaks, and organizes the information into structured input for further processing. The output is preprocessed, aggregated time-series datasets.

### Step 6

The server generates a prompt sentence summarizing the preprocessed data and submits it to a generative AI model (such as a language model) via an API. The input is the aggregated and preprocessed dataset with key statistics. The server formats a prompt such as: “Based on the following monthly energy usage and CO2 emission data, recommend the best renewable energy investment.” The output is a prompt sentence and an analytical response from the generative AI model.

### Step 7

The server parses the analytical response from the generative AI model and creates an optimization plan, which may include ranked equipment installation proposals, estimated investment effects, payback periods, and efficiency improvements. The input is the AI model's structured output. The server uses logic and financial calculation modules to further refine the plan, selecting the most effective proposal. The output is a finalized optimization plan detailing recommended actions.

### Step 8

The server generates a proposal document containing the optimization plan, supporting data, visualizations, and recommendations. The input is the finalized optimization plan from Step 7. The server arranges the data into a predefined report template, uses graphing libraries to create charts, and exports the document as a PDF or other file format. The output is a comprehensive proposal document ready for distribution.

### Step 9

The user accesses the generated proposal document through a user interface, such as a web dashboard or application. The input is the proposal document provided by the server. The user reviews the report, analyzes visualized metrics and recommendations, and can download or share the document as needed. The output is user feedback and potential decision-making based on the generated report.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In current industrial and facility environments, real-time management of energy consumption and CO2 emission data is essential for efficient operation and achieving environmental goals. However, there is a lack of effective systems that collect, preprocess, and analyze such diverse data in real time, and that generate optimal renewable energy investment proposals based on advanced artificial intelligence models. Furthermore, existing solutions do not provide sufficient support for rapid and collaborative decision-making among multiple administrators, nor do they adapt their recommendations based on the emotional responses or understanding levels of users. Additionally, continuous optimization after the installation of renewable energy equipment based on real-time operational feedback is not sufficiently realized.

The specific processing by the specific processing unit 290 of the data processing device 12 in Application Example 1 is realized by the following means.

The present invention provides a server comprising a processor configured to collect and preprocess real-time physical measurement data and emission data, analyze said data with a generative artificial intelligence model using prompt sentences, generate and adapt investment proposal reports based on user emotion recognition, and present these reports through electronic or virtual displays permitting interactive and collaborative operation. This enables real-time generation and optimized presentation of renewable energy investment proposals, collaborative decision-making, adaptive user support based on emotion analysis, and continuous feedback and optimization after system installation.

The term “information acquisition device” refers to any hardware apparatus that obtains and transmits physical measurement data such as energy consumption or emission data from equipment or facilities in real time.

The term “physical measurement data” refers to quantitative data collected from sensors, meters, or other measurement hardware indicating factors such as power consumption, gas usage, or other relevant physical parameters.
The term “emission data” refers to data quantifying amounts of exhaust substances, such as carbon dioxide or other greenhouse gases, generated as a byproduct of energy consumption or industrial processes.
The term “data processing apparatus” refers to any computing hardware and associated software capable of receiving, storing, and manipulating collected measurement data for subsequent analysis.
The term “preprocessing” refers to operations performed on raw data to verify data consistency, detect and correct anomalies, and prepare the data for further computational analysis.
The term “consistency verification” refers to procedures for checking the integrity, completeness, and logical correctness of the collected data prior to further processing or analysis.
The term “anomaly detection and correction” refers to the identification and correction of abnormal data points or irregular patterns in the measurement data, typically using statistical or computational methods.
The term “prompt sentence” refers to a natural language instruction or query formulated for input into a generative artificial intelligence model to guide its analysis and output.
The term “generative artificial intelligence model” refers to a computer algorithm or system utilizing machine learning and natural language processing techniques to analyze input data and generate outputs such as investment proposals or recommendations.
The term “natural language processing model” refers to a type of artificial intelligence model that processes, understands, and generates human language text for various functions including pattern recognition and report creation.
The term “investment proposal” refers to an automatically generated plan or recommendation regarding the introduction or optimization of renewable energy systems, including suggested equipment, expected cost, and anticipated benefits.
The term “user emotion information” refers to data representing the emotional state or reactions of a user, as discerned from sources such as operation logs, speech, or visual cues.
The term “emotion recognition unit” refers to a module, software, or hardware capable of detecting and analyzing the emotional condition of a user based on multimodal input such as facial expression, voice, and user behavior.
The term “investment proposal report” refers to an electronic document or presentation that summarizes analysis results, recommendations, and other information generated by the system for user review and decision-making.
The term “virtual reality display” refers to a head-mounted or otherwise immersive device that presents visual information to the user in a format that mixes or augments the real environment with digital data.
The term “electronic display device” refers to any hardware such as monitors, tablets, or dashboards that display visual content or reports generated by the system.
The term “collaborative decision-making” refers to the process by which multiple users or administrators interactively communicate, discuss, and agree upon actions based on system-generated reports or data.
The term “comment management” refers to functionalities within the system that allow users to append, share, manage, and review annotations or feedback related to the reports or data presented.

One embodiment of the present invention will be described in detail below. The system is constructed to collect, preprocess, analyze, and present energy-related data in real time, and to generate, adapt, and display investment proposals for renewable energy systems by using a generative artificial intelligence model. The overall system comprises at least one terminal (information acquisition device), a server (data processing apparatus), and at least one user interface such as an electronic display device or a virtual reality display.

The terminal, equipped with a processor, sensors, and network communication hardware, continuously acquires physical measurement data such as energy consumption (for example, electric power and gas usage) and emission data such as CO2 emissions from various monitoring points. Specific hardware examples include general-purpose microcontrollers (e.g., ARM-based boards) and energy/CO2 sensors linked via standard protocols such as Modbus or MQTT. The terminal formats the collected data into standardized digital messages, attaches identification and timestamp information, and transmits the messages to the server via a network such as Ethernet or Wi-Fi.
The server, comprising high-performance computing hardware such as a general-purpose server or a cloud-based virtual machine, receives data from multiple terminals. The server stores this data in a database such as a relational database system (e.g., PostgreSQL or Amazon Aurora). Through data preprocessing software, for example, using the Pandas and NumPy libraries in the Python programming language, the server verifies the consistency of the received data, detects missing values or outliers, and corrects anomalies according to predetermined rules. For example, if the server detects an abnormal spike in electrical power readings, it applies either replacement with previous average values or interpolates based on surrounding data points.
After preprocessing, the server generates a prompt sentence, combining natural language instructions with formatted energy and emission data. This prompt is fed into a generative artificial intelligence model (for example, based on large language models such as those provided by commercial cloud AI APIs). The server invokes this model through a RESTful API, and the generative AI model performs comprehensive analysis including pattern recognition, trend analysis, and identification of optimal strategies for renewable energy investment. The output includes proposed installations (such as the number and location of solar panels or wind turbines), estimated costs, predicted payback periods, and anticipated reductions in emissions. Additionally, the server is configured to monitor user's emotional response while viewing the investment proposal report via a user interface such as a head-mounted display (for example, a general-purpose industrial AR headset) or a dashboard on a PC. The server uses an emotion recognition module, which may analyze the user's facial expression (via a webcam), voice tone (via a microphone), or comments (via input interface), applying standard real-time analysis software (e.g., commercially available emotion recognition APIs or machine vision libraries). When an emotion such as doubt or hesitancy is detected, the server dynamically modifies the report content, for example, by adding extra explanations or visual aids, so as to improve user understanding and confidence.
The server then formats the final investment proposal report for presentation on the user's display device. It allows the user to interact using modalities such as voice commands or touch inputs to retrieve additional information, detailed breakdowns, or alternative proposals. Furthermore, the system is designed for collaborative usage, so the server may distribute the same report and data, in real time, to multiple users or administrators to facilitate group discussion or annotation. Once the proposed renewable energy system has been implemented, the terminal continues to collect and transmit post-installation operational data. The server periodically analyzes this data using the same generative AI model and provides optimization feedback to the user interface. For example, the server may propose to adjust settings on energy equipment or suggest further actions to maximize cost savings and emission reductions.
A specific example is as follows: A user installs several terminals throughout a manufacturing facility to collect real-time energy and emission data. The server receives and processes this data. The server generates a prompt such as:
“Analyze the following energy consumption and CO2 emission data from our manufacturing site. Identify any abnormal trends and generate an investment proposal for renewable energy systems, specifying the equipment, location, initial cost, payback period, and expected environmental impact.”
The generative AI model then produces a detailed proposal. When the system detects that the user is confused by the financial summary, it automatically adds supplemental explanations and clearer visualizations to the report.
This embodiment enables organizations to automate the real-time analysis and proposal of renewable energy investments, adapt presentation and communication to user comfort and understanding, and continually optimize facility operations based on live feedback data.

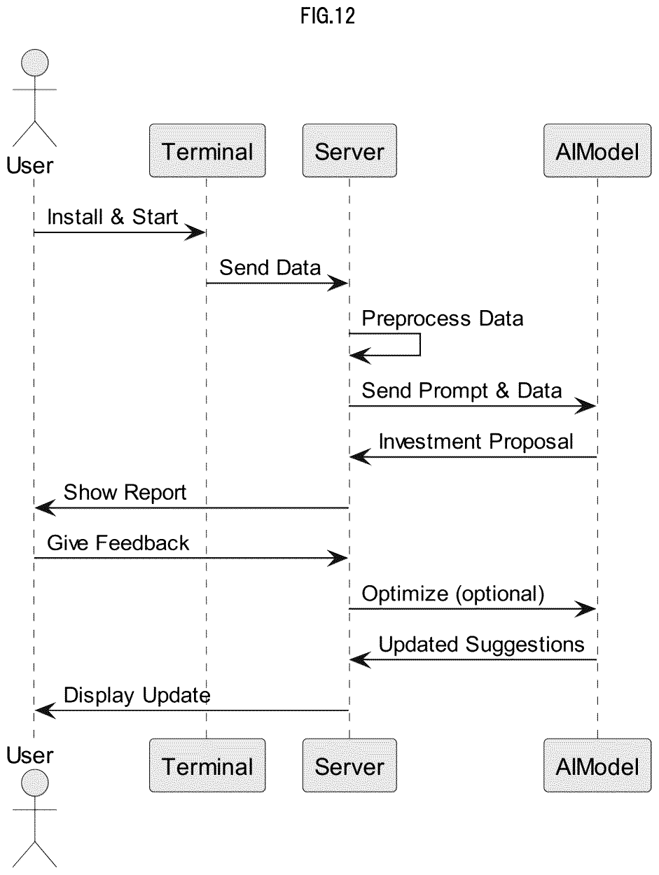

The following describes the processing flow using FIG. 12.

### Step 1

The terminal collects physical measurement data such as power consumption, gas usage, and CO2 emission values from installed sensors at specified intervals, typically every minute. The terminal formats the data into a standard digital message (for example, a JSON string), attaches a timestamp and a unique device identifier, and transmits the data to the server using a network protocol such as MQTT.
Input: Sensor readings (power, gas, CO2, etc.)
Output: Structured measurement data message sent to the server

### Step 2

The server receives measurement data messages from one or more terminals over the network. The server parses each incoming message, logs the raw data, and stores it in a centralized database, such as a relational database system. The server checks the message validity and records metadata for further processing.
Input: Structured measurement data message
Output: Logged and stored raw measurement data in the database

### Step 3

The server preprocesses the stored data by performing data consistency checks, such as verifying timestamp order, detecting missing or duplicated values, and identifying anomalies (such as abnormally high or low readings). The server applies data correction algorithms, for example, by interpolating missing values or replacing outliers with moving averages. The server also tags the cleansed data with contextual information (such as area, time slot, or device type).
Input: Logged raw measurement data from the database
Output: Preprocessed and tagged measurement data

### Step 4

The server generates a prompt sentence by combining a natural language instruction with a summary or time-series table of the preprocessed measurement data. The prompt is designed to request analysis and recommendations from an artificial intelligence model.
Input: Preprocessed and tagged measurement data
Output: Prompt sentence and formatted data package for AI input

### Step 5

The server submits the generated prompt sentence and the corresponding measurement data to a generative AI model via an API request. The generative AI model analyzes the temporal patterns and trends in the data, identifies inefficiencies or abnormal trends, and generates a comprehensive recommendation for renewable energy investment, including device types, quantities, placement, cost, payback period, and expected emission reduction.
Input: Prompt sentence and formatted data package
Output: Structured investment proposal and insight report

### Step 6

The server creates an investment proposal report by arranging the AI-generated recommendations, statistics, and visualizations in a format suitable for user display. The report includes charts, tables, explanatory text, and summaries relevant to decision making.
Input: Structured investment proposal and insight report
Output: Formatted investment proposal report for user display

### Step 7

The user accesses the investment proposal report through an electronic display device or a virtual reality display. As the user views the report, the server collects user feedback such as operation logs, spoken comments, or facial expressions via connected input devices.
Input: Formatted investment proposal report
Output: User feedback data (operation history, voice, facial expressions, etc.)

### Step 8

The server processes the user feedback using an emotion recognition module, which analyzes the user's reactions and determines emotional states such as confidence, understanding, or hesitation. Based on the detected emotion, the server customizes the report presentation, for example by adding additional explanations or visual cues to address user confusion or anxiety.
Input: User feedback data
Output: Customized investment proposal report presentation

### Step 9

The server distributes the customized report and real-time data to multiple users or administrators, enabling collaborative review and commenting. The server synchronizes report annotations or decisions among participants.
Input: Customized investment proposal report and real-time measurement data
Output: Synchronized, collaborative user interface for team decision making

### Step 10

After the renewable energy systems are installed, the terminal continues to measure and transmit operational data. The server periodically analyzes this operational data using the generative AI model, updates performance reports, and provides ongoing optimization feedback to the user interfaces.
Input: Post-installation operational measurement data
Output: Updated performance reports and optimization suggestions

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In recent years, there has been an increasing need for enterprises and organizations to efficiently reduce energy consumption and greenhouse gas emissions, both to meet regulatory requirements and improve cost performance. However, existing solutions lack the ability to dynamically collect, process, and analyze multi-faceted energy utilization data, including user state or emotion, in real time and to generate optimized, actionable investment proposals tailored to the specific needs and responses of users. It is also difficult to quickly validate data integrity, correct anomalies, and flexibly refine recommendations based on direct and indirect user feedback.

The specific processing by the specific processing unit 290 of the data processing device 12 in Example 2 is realized by the following means.

The present invention provides a server comprising a processor configured to dynamically acquire energy utilization information including biometric information, store and preprocess said information, analyze the preprocessed information and generate proposal information using a generative information processing model, create and visualize a report, identify and analyze user status information, and optimize the proposals accordingly. This enables precise real-time data analysis, adaptive investment recommendation, and tailored user engagement through iterative feedback and emotion-based customization.

The term “energy utilization information” refers to data that represents the amount, pattern, or characteristics of energy used within a facility or by equipment, and may include details such as consumption volume, frequency, duration, and related metrics.
The term “biometric information” refers to data that is derived from physiological or behavioral characteristics of a user, such as facial expressions, voice patterns, or input behavior, for the purpose of recognizing or analyzing the user's status or emotions.
The term “information acquisition device” refers to a hardware unit or sensor system capable of measuring and collecting energy usage data and biometric data in real time from a physical environment.
The term “information processing apparatus” refers to a computational device or server configured to receive, store, and preprocess data acquired from information acquisition devices.
The term “preprocess” refers to the operations performed on raw data for formatting, normalization, anomaly detection, correction, encapsulation, and tagging prior to further analysis.
The term “generative information processing model” refers to a machine learning model or software algorithm that analyzes input data and generates new, context-specific informational content or recommendations, such as investment proposals, based on learned patterns.
The term “proposal information” refers to recommendations, plans, or suggested actions generated by a generative information processing model to address energy optimization or investment objectives.
The term “report” refers to a compiled and structured document or interface that presents proposal information and relevant analysis results in a user-comprehensible format.
The term “information presentation terminal” refers to an output device or user interface, such as a display screen or dashboard, that presents the report and visualized data to the user.
The term “user status information” refers to data representing the state, behavior, feedback, or emotional response of a user while interacting with the system.
The term “optimize the proposal information” refers to the process of modifying, reformulating, or customizing recommendation content based on user status information, feedback, or detected preferences to enhance relevance and effectiveness.

An embodiment for implementing the invention described in the claims is provided below.

In this system, the terminal operates as an information acquisition device that is installed in an environment such as a building, a factory, or another facility. The terminal comprises various sensor hardware, such as energy meters, gas meters, environmental sensors, and biometric sensors, to collect energy utilization information and biometric information in real time. By using protocols such as MQTT, the terminal transmits this collected data securely and reliably to the server over a communication network.
The server functions as an information processing apparatus equipped with hardware resources such as a central processing unit (CPU), data storage systems (for example, cloud-based database services such as a relational database service), and accelerator devices if needed. The server executes software that handles the reception, storage, and preprocessing of energy utilization information. Preprocessing tasks may include integrity checking, normalization, error correction, encapsulation, and tagging of the data, using software frameworks such as Python with popular data processing libraries.
Once the data has been preprocessed, the server utilizes a generative information processing model to analyze the information and generate proposal information. For this purpose, the server may incorporate commercially available or custom-developed generative AI models, such as a recent large language model accessible via a cloud-based API. The model is provided with relevant prompt sentences and summarized data in order to generate tailored recommendations, investment plans, or action proposals for energy system optimization.
The server compiles proposal information into a report, which may be formatted using document generation software or web-based visualization tools. The report is then transmitted to and displayed at the information presentation terminal. This terminal may be a user's computer, smartphone, or dedicated display, running standard web browsers or application software. In parallel, the server acquires user status information by analyzing user interactions, including explicit feedback submitted via forms and implicit biometric data captured through connected input devices, such as web cameras for facial analysis or microphones for emotion analysis. To process these data, the server may utilize application programming interfaces (APIs) for biometric and sentiment analysis provided by general-purpose software platforms.
By combining user status information and proposal information, the server can iteratively optimize the content and structure of the report. For example, if analysis shows that the user is confused or requests clarification, the generative information processing model can be prompted again, with new instructions, to adjust the recommendation.
As a concrete example, in a manufacturing facility, terminals are installed on each production line to collect energy and process data, while user interactions are monitored at a web-based dashboard. When reviewing the investment proposal, user response data are integrated with operational statistics, enabling generation of a customized report that explains technical terms in detail or provides additional scenarios according to user needs.
An example of a prompt sentence given to the generative AI model could be:
“Please generate an optimal investment plan to maximize cost savings from introducing an industrial solar power generation system, based on the provided energy consumption and CO2 emission data. Also, explain how to customize the plan considering the user's emotional data collected during report review.”
Through these steps, the system realizes flexible, context-aware data analysis and user-specific optimization, resulting in an energy management and investment decision-making platform that adapts to both operational requirements and user feedback.

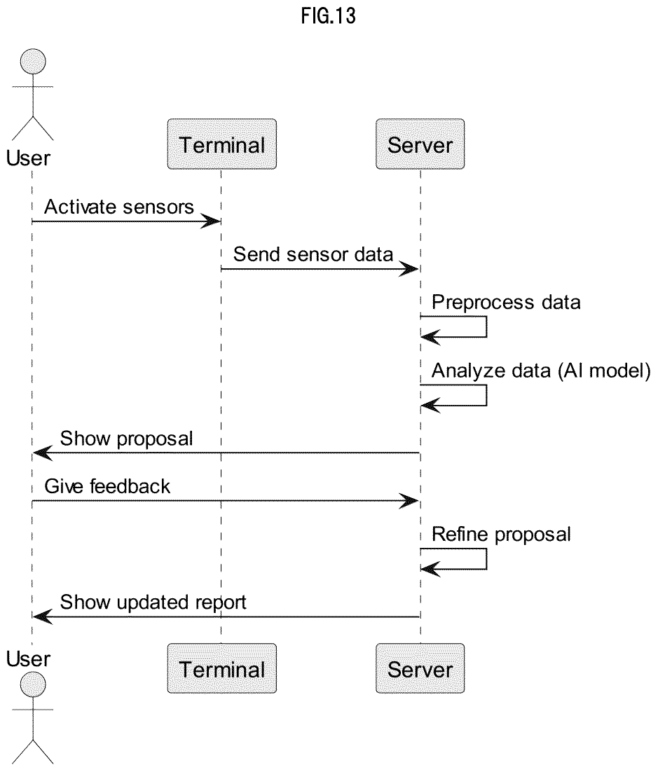

The following describes the processing flow using FIG. 13.

### Step 1

The terminal collects raw energy utilization information and biometric information from various sensors, such as energy meters, gas meters, environmental sensors, and biometric devices, installed throughout the facility. The input is real-time sensor data, such as power consumption, gas usage, and biometric readings. The terminal processes the sensor signals into structured data packets with timestamps and device IDs, then transmits the packets to the server using a network communication protocol, for example, MQTT. The output is a data stream of structured messages sent to the server.

### Step 2

The server receives the data stream from the terminal and processes the incoming messages. The input is the structured message data sent from the terminal. The server stores the raw data in a database, such as a cloud-based relational database service. The server then preprocesses the data by performing integrity checking, detecting and correcting anomalies, normalizing values, adding relevant tags, and encapsulating data records. The output is a preprocessed, reliable dataset stored and organized for further analysis.

### Step 3

The server analyzes the preprocessed data using a generative AI model. The input is the reliable dataset output from the preprocessing step. The server creates a prompt sentence that summarizes the data and instructs the AI model to produce tailored recommendations and investment proposals. The server sends the prompt and data to the AI model, processes the generated proposal, and extracts structured recommendation information, including cost-benefit analyses, recommended technologies, and projected effects. The output is a set of proposal information and recommendations generated by the AI.

### Step 4

The server monitors the user as they interact with the information presentation terminal, such as a web dashboard, to collect user status information. The input is the user's behavioral and biometric data, including facial expressions, voice tone, input patterns, and feedback comments, as detected by connected hardware and analysis software. The server uses emotion analysis APIs and user interaction logs to identify and interpret the user's emotional state and responses to the proposals. The output is user status information and emotion analysis results associated with the ongoing session.

### Step 5

The server optimizes the proposal information by integrating the results from the generative AI model and the user status information. The input is the AI-generated proposal and the emotion analysis results. The server modifies, reformulates, or annotates the proposal to address user needs, such as adding simplified explanations, expanding on specific sections, or offering alternative scenarios. The server generates a customized report and visualizes it on the information presentation terminal. The output is a user-optimized and interactive report accessible by the user.

### Step 6

The user provides feedback or requests additional information via the dashboard. The input is the feedback data or requests submitted by the user interface. The server collects this feedback and determines whether to initiate another round of data analysis or content generation using the generative AI model, incorporating the latest user feedback and emotional context. The output is an updated proposal and report, iteratively refined until user requirements are met.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In business and industrial facilities, optimizing energy usage and reducing environmental emissions such as CO2 is a critical yet challenging issue, particularly due to difficulties in collecting and analyzing real-time data. Furthermore, it is problematic to generate truly effective investment proposals for renewable energy systems without considering user emotions, which may influence decision-making and the acceptance of recommended actions. There is also a lack of systematic feedback and monitoring mechanisms after the implementation of such proposals, impeding continuous improvement and adaptation.

The specific processing by the specific processing unit 290 of the data processing device 12 in Application Example 2 is realized by the following means.

The present invention provides a server comprising a processor configured to continuously obtain energy usage state information and environmental emission information from a plurality of information acquisition devices, to store and preprocess said information, to analyze the preprocessed information and generate proposal information automatically, to acquire and analyze user emotion information, to adjust and generate presentation information in response to the analysis and emotion data, and to present said adjusted information to a user, while further supporting operational monitoring and feedback after equipment introduction. This enables the real-time and emotion-sensitive optimization of energy use and emissions, the generation of tailored and effective investment proposals, and the ongoing improvement of energy-related activities through systematic monitoring and feedback.

The term “energy usage state information” refers to data representing the amount, timing, and pattern of energy consumed by one or more systems or facilities.

The term “environmental emission information” refers to data representing the production or release of substances, such as carbon dioxide or other greenhouse gases, from one or more systems or facilities.
The term “information acquisition device” refers to a hardware unit or apparatus capable of measuring, detecting, or collecting data related to energy usage or environmental emissions.
The term “processor” refers to an electronic data processing unit that controls, manages, and executes instructions for data acquisition, storage, analysis, and presentation.
The term “preprocessing” refers to any data processing operation-such as integrity verification, removal or correction of abnormal values, normalization, or formatting-performed on raw information before main analysis.
The term “proposal information” refers to automatically generated recommendations or plans regarding the adoption or improvement of systems, equipment, or processes for reducing energy consumption and/or environmental emissions.
The term “user emotion information” refers to data representing a user's emotional state, obtained from sources such as facial expressions, vocal characteristics, written feedback, or physiological signals.
The term “emotion analysis mechanism” refers to a hardware or software system configured to detect, identify, and classify a user's emotional state based on user emotion information.
The term “presentation information” refers to content, documents, or report data presented to the user, specifically tailored or adjusted based on analysis and/or user emotion information.
The term “operational status” refers to the state of functioning, performance, or behavior of installed equipment or systems after the introduction of proposal information.
The term “evaluation information” refers to data or feedback collected concerning the effectiveness, efficiency, or outcome of systems or processes that have been modified or introduced based on proposal information.

An embodiment for implementing the present invention will now be described in detail. The system comprises a processor, one or more information acquisition devices (such as sensor-equipped robots or IoT terminals), and a user interface accessible by authorized users. The processor is typically implemented as a server within an information processing apparatus, while the information acquisition devices are distributed throughout the target facility or facilities. In one specific example, the information acquisition devices are integrated into factory robots and equipped with sensors for measuring energy usage (such as electricity consumption and gas flow meters) and environmental emission quantities (such as carbon dioxide emission sensors). Each device is further equipped with a communication module, such as a Wi-Fi unit, that enables data transmission to the server via a computer network.

The server receives and stores energy usage state information and environmental emission information from each information acquisition device. The server performs preprocessing on the received data, such as integrity verification and abnormal value correction. For example, abnormal spikes in power consumption due to sensor error can be identified and corrected by established data-cleaning algorithms implemented as part of the server's data pipeline. This preprocessing may be executed using data analysis tools and libraries, such as Python with Pandas, or distributed processing frameworks such as Apache Spark, depending on system scale and requirements. The preprocessed data is then registered in a database, which can be provided by a general cloud infrastructure.
The server analyzes the preprocessed data using a generative AI model, which may be implemented using a machine learning framework such as TensorFlow or PyTorch. The generative AI model identifies trends and patterns in the energy usage and emission data, and automatically generates proposal information, which may include recommendations for adopting or upgrading systems, equipment, or operational processes to achieve energy and emission optimization.
The system further acquires user emotion information during the user's interaction with the report or proposal. The user views the generated proposal information on a dashboard, typically via a personal computer or smart device. With the user's consent, the processor collects user emotion information, including facial expression data (using a webcam), voice characteristics (using a microphone), or textual feedback (inputted via the dashboard). The server analyzes this user emotion information using an emotion analysis mechanism such as an image processing library (for example, OpenCV) or a specialized emotion recognition application programming interface (such as Emotion API or software provided by a cloud service platform).
Based on the combined result of the proposal content and the detected user emotion, the server creates and adjusts presentation information to optimize clarity, persuasiveness, and user comfort. For instance, if the emotion analysis mechanism identifies user concern (negative), the processor automatically adds explanatory language addressing financial concerns, risk mitigation strategies, or support programs to the proposal. If positive emotion is identified, the processor may emphasize projected benefits and encouraging trends.
The finalized presentation information is made available to the user via a user interface, such as a web-based dashboard. The user is able to review, consider, and provide further feedback through this interface. The server may continuously monitor operational status after the implementation of new equipment or procedures recommended by the proposal. Evaluation information, such as system performance metrics, can be fed back into the analysis and used to further improve proposal generation and report customization.
Hardware and software specifically mentioned in this embodiment may include: sensor-equipped industrial robots or IoT edge devices for information acquisition, Wi-Fi modules and secure networking hardware for communication, a server or cluster acting as the processor (using standard server hardware), a database system such as a relational cloud database for data storage, the TensorFlow or PyTorch framework for generative AI model operation, Python with data analysis libraries for preprocessing, OpenCV or an API-based emotion analysis platform for emotion detection, and a web-based dashboard implemented, for example, using React.js or Angular as the frontend technology.
As a concrete example, consider a manufacturing plant in which robots equipped with energy and emission sensors are installed at various points. Each robot collects data in real-time and transmits it via Wi-Fi to the server, where it is preprocessed and analyzed. The server generates a customized proposal for investment in renewable energy technologies. When the plant manager reviews the proposal, the dashboard collects user feedback, facial images, and speech recordings, which are analyzed for sentiment. The proposal content is then adapted according to the manager's detected emotional response, and a tailored report is presented. For example, if a hesitation is detected, additional information about financing options or phased implementation may be presented.
A typical prompt sentence used in the system for the generative AI model may be as follows: “Analyze the user's emotional reaction using the provided input. Based on the facial image, audio recording, and the user's written statement, classify the emotion as positive, neutral, or negative. Input: face image file, voice file, user's feedback text: ‘The initial cost is a concern, but the long-term benefit is attractive.”’
This architecture enables automated, data-driven, and user-adaptive management of energy and environmental impact in organizational settings.

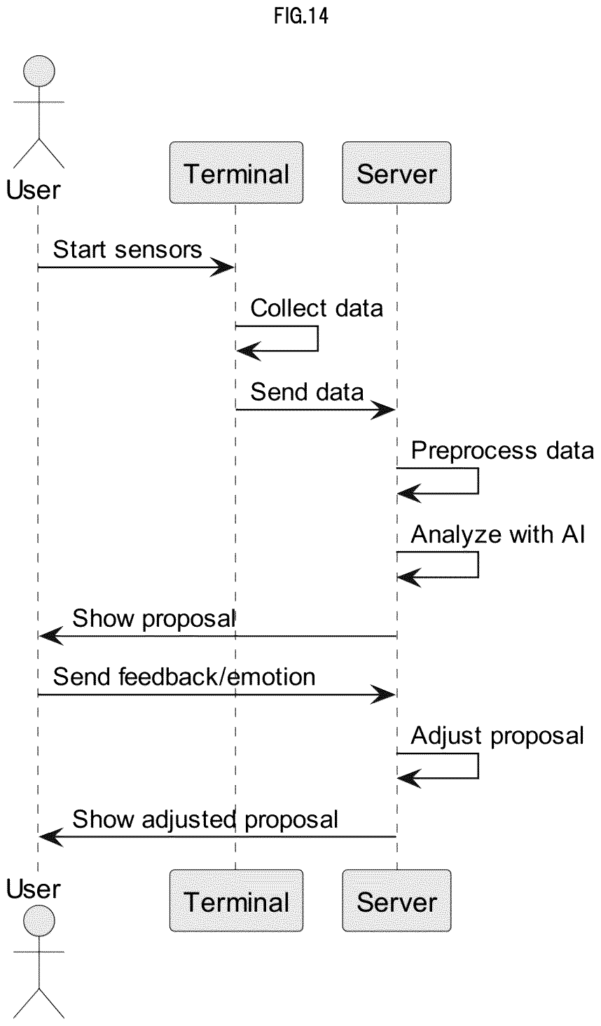

The following describes the processing flow using FIG. 14.

### Step 1

Terminal acquires raw data from various onboard sensors, including sensors measuring energy consumption (such as electricity and gas usage) and sensors measuring environmental emissions (such as CO2 levels).
Input: Physical measurements captured by sensors at regular intervals.
Output: Digitally formatted, timestamped energy and emission data records stored temporarily in local memory.
   The terminal converts the analog sensor signals into digital data, attaches device and timestamp metadata, and performs basic validation such as checking for missing or unreasonable values.

### Step 2

Terminal transmits the buffered sensor data to the server via a secure Wi-Fi connection.
Input: Validated and formatted sensor data records in local memory, network connection parameters.
Output: Data packets successfully delivered and acknowledged by the server.
   The terminal establishes a connection using wireless network hardware, formats the data into transmission packets, and initiates a secure send operation using protocols such as HTTPS or MQTT.

### Step 3

Server receives the transmitted data packets from terminals and stores the raw data in a database.
Input: Incoming data packets comprising energy and emission measurements sent from one or more terminals.
Output: Entries in a persistent database storing the received measurement records.
   The server listens for incoming network traffic, verifies the integrity of each packet, parses the data, and stores each record with metadata in structured database tables.

### Step 4

Server preprocesses the stored data by checking for duplicate entries, correcting abnormal values, interpolating or removing missing data, and normalizing the data for consistent format and range.
Input: Raw data records retrieved from the database.
Output: Cleaned and preprocessed data sets, ready for further analysis.
   The server runs data cleansing algorithms, such as outlier detection (using statistical methods), time-series interpolation for missing points, and normalization scripts using data analysis libraries.

### Step 5

Server analyzes the preprocessed data using a generative AI model implemented with a machine learning framework.
Input: Preprocessed, validated, and normalized energy and emission data sets.
Output: Analytical results identifying usage patterns, and automatically generated investment proposals with detailed rationale.
   The server loads the processed time-series data into a generative AI model, which performs trend analysis, predicts future usage/emission trends, and produces recommendations for efficiency improvements or renewable system investments.

### Step 6

User accesses a dashboard provided by the server to view the generated proposal report.
Input: Dashboard login credentials, user authentication data, and the proposal report generated by the AI model.
Output: On-screen display of a comprehensively organized investment proposal report with charts, tables, and narrative explanations.
   The user interacts with the dashboard via a web browser or smart device, and the server ensures secure presentation and navigation of the report.

### Step 7

Server collects user emotion data during the user's review of the proposal, through webcam images, voice samples, and feedback text (with user consent).
Input: Real-time facial image files, audio recordings, and textual feedback captured during report review.
Output: User emotion classification result (such as positive, neutral, or negative) and a structured data record linking emotion to the review session.
   The server receives emotion data, processes image and audio using an emotion analysis mechanism (such as OpenCV or Emotion API), and uses natural language processing to analyze textual feedback.

### Step 8

Server optimizes the presentation of the proposal report by adjusting content, explanations, or emphasis based on the detected user emotion.
Input: Generated proposal report, user emotion classification results.
Output: Tailored proposal report with modified language and highlighted points corresponding to user sentiment.
   The server revises the textual and visual aspects of the report, such as adding reassurance language for detected negative emotions or emphasizing benefits for positive emotions, and regenerates a customized report.

### Step 9

User reviews the optimized report, may provide additional feedback, and makes decisions regarding the proposed investments.
Input: Tailored proposal report and feedback interface on the dashboard.
Output: User actions or decisions, additional feedback submitted through the interface.
   The user navigates the adjusted report, evaluates the information, and can submit further comments or approval/rejection as desired. The server collects this new feedback for future analysis.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

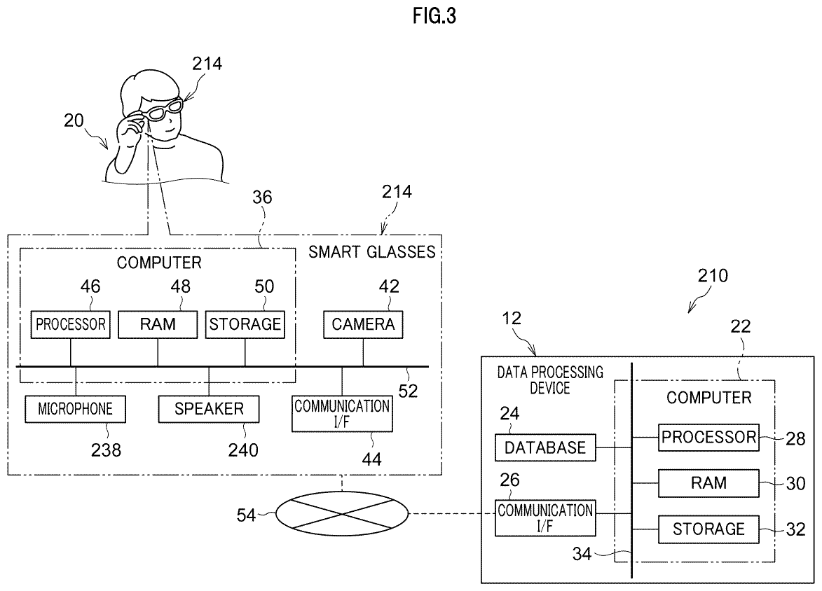

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

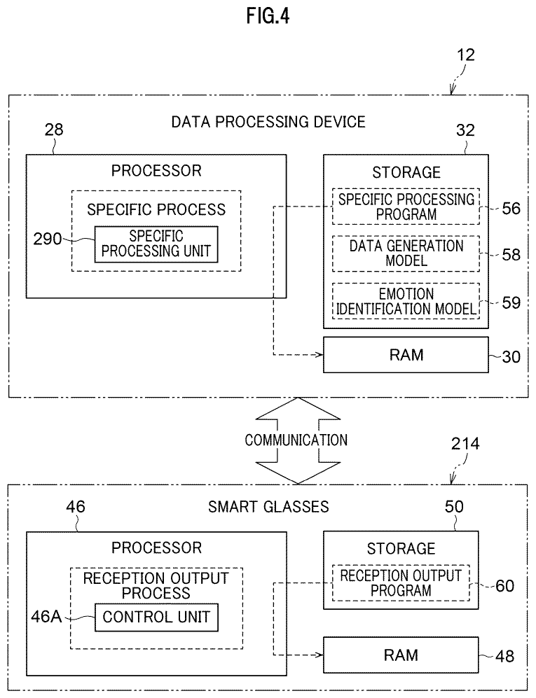

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

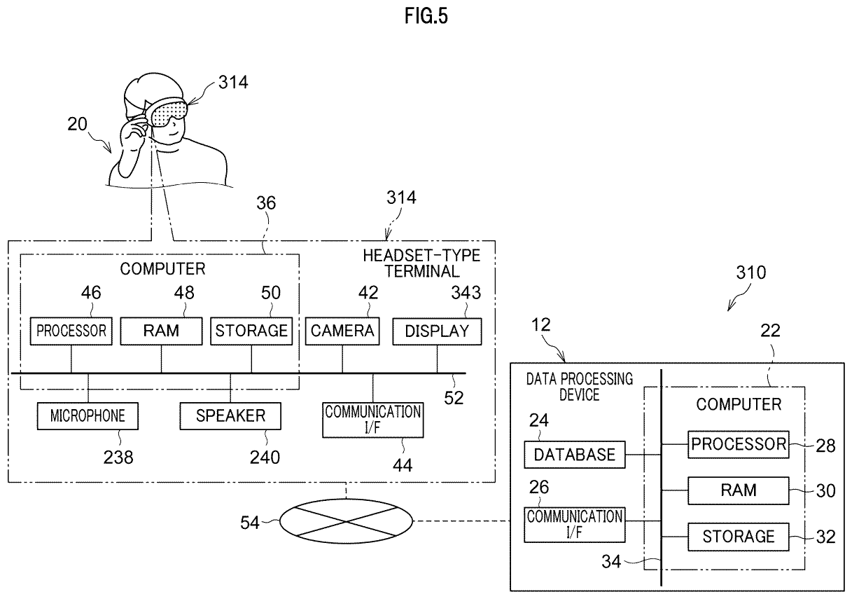

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

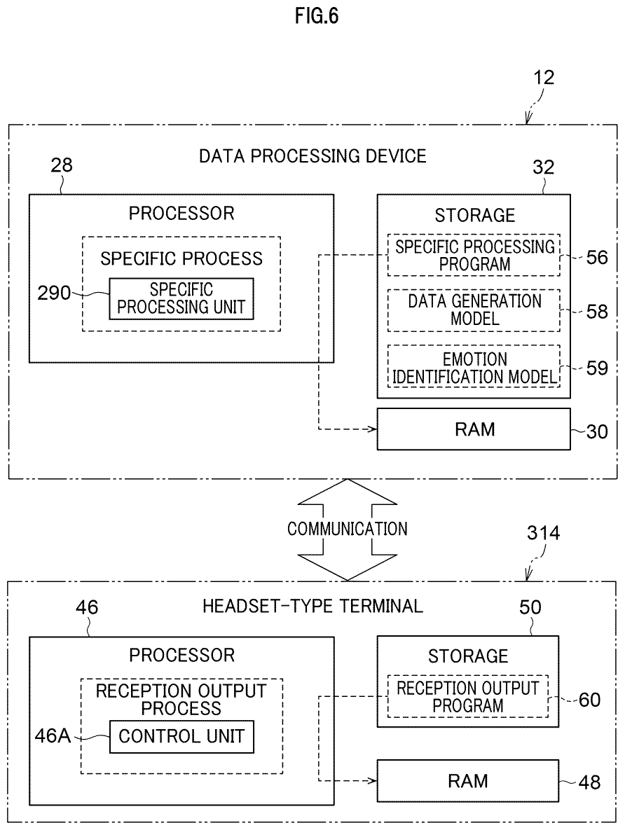

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

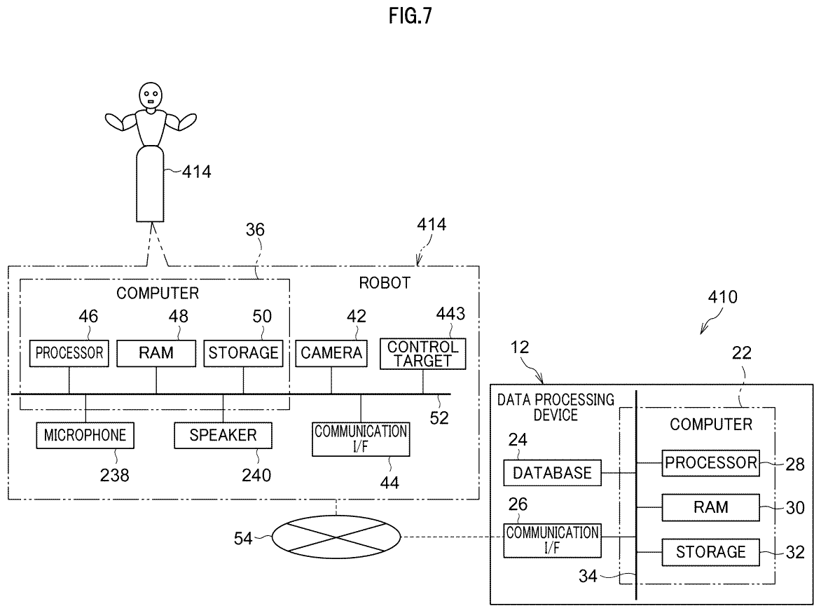

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

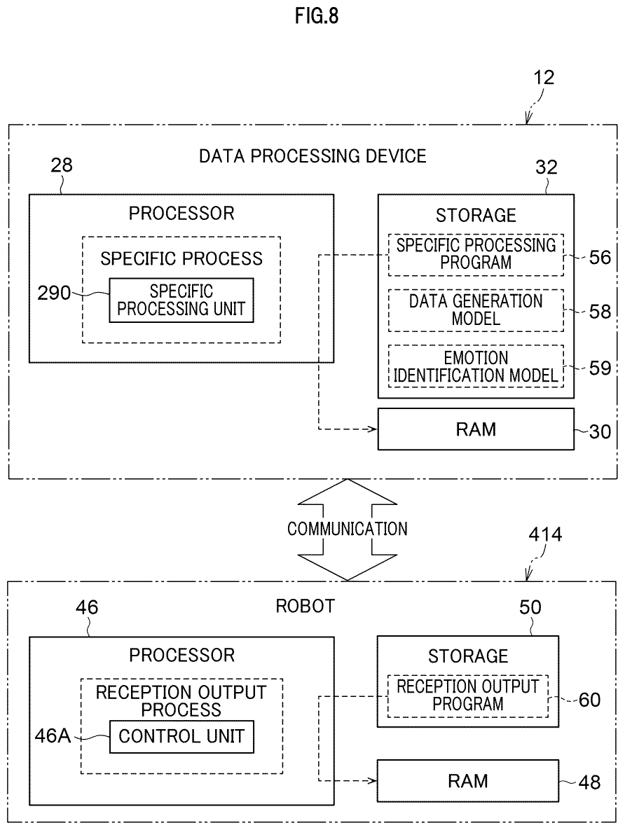

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

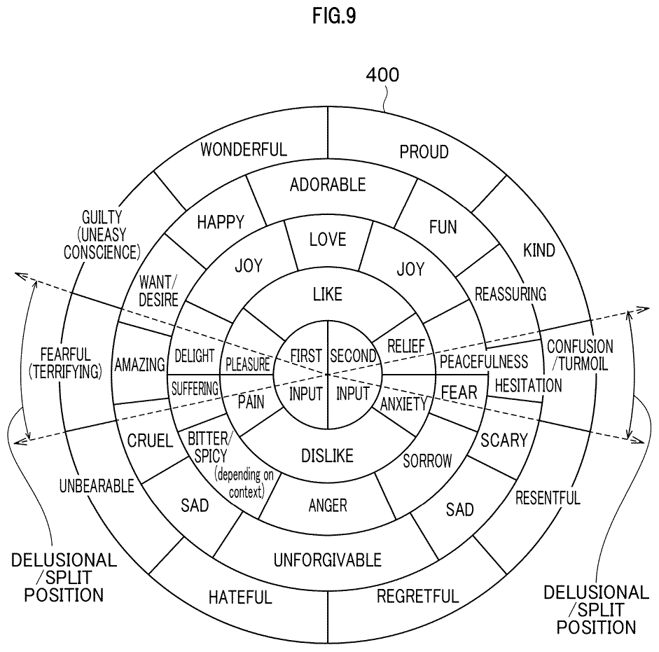

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

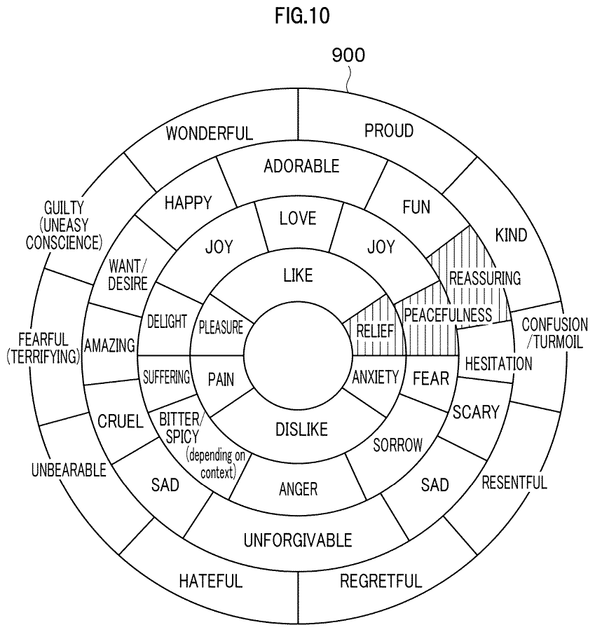

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
collect in real time, from measuring devices installed at a location, a plurality of types of environmental-related data;
store received data in a structured database on a data storage apparatus and perform periodic backup;
verify the integrity and correct anomalies in the received data, including timestamp information and identifiers, on the data storage apparatus;
aggregate preprocessed environmental-related data and generate a predetermined prompt sentence for a generative artificial intelligence model, and transmit the prompt sentence to the generative artificial intelligence model;
analyze, by the generative artificial intelligence model, consumption trends and emission trends of the environmental-related data based on the prompt sentence, and output an optimization plan including an equipment installation plan;
rank, on an investment planning management apparatus, a plurality of equipment installation plans based on evaluation indices according to the output result of the generative artificial intelligence model, and generate a proposal document in a predefined format;
and provide and make available the proposal document to a user through a user interface via a network.

### Supplementary 2

The system according to supplementary 1,
wherein the processor is configured to
include, during equipment installation planning, a computational process that quantitatively calculates an investment effect, investment payback period, efficiency improvement estimate, and emission reduction estimate.

### Supplementary 3

The system according to supplementary 1,
wherein the processor is configured to periodically acquire environmental-related data generated by measuring devices at the location after equipment installation, monitor actual investment effect and emission reduction effect, and provide improvement proposals to a user.

### Application Example 1

### Supplementary 1

A system comprising a processor,
wherein the processor is configured to
collect physical measurement data and emission data in real time using an information acquisition device,
store and preprocess the received data in a data processing apparatus,
perform consistency verification and anomaly detection and correction during said preprocessing,
input a prompt sentence and the preprocessed data into a generative artificial intelligence model including a natural language processing model, to automatically generate an investment proposal by executing analysis of multiple time series information, patterns, and trends,
analyze user emotion information such as operation history, voice information, and video information by an emotion recognition unit, and generate and present an investment proposal report by adapting the proposal content or display content in accordance with the analysis result, present the investment proposal report and real-time data via a virtual reality display or electronic display device, enabling the user to obtain data or proposal content through a voice command,
and distribute the investment proposal report and data to a plurality of administrators simultaneously, enabling collaborative decision-making and comment management.

### Supplementary 2

The system according to supplementary 1,
wherein the processor is configured to
control the change of display layout or description content based on the user emotion recognition result for the investment proposal report.

### Supplementary 3

The system according to supplementary 1,
wherein the processor is configured to
continuously collect operational measurement data after the introduction of renewable energy equipment using the information acquisition device, and present feedback information for optimization to the user by analysis using the generative artificial intelligence model.

### Example 2

### Supplementary 1

A system comprising a processor,
wherein the processor is configured to
acquire energy utilization information including biometric information dynamically from an information acquisition device,
store and preprocess the acquired energy utilization information in an information processing apparatus,
analyze the preprocessed energy utilization information and generate proposal information using a generative information processing model,
create a report from the proposal information and visualize the report on an information presentation terminal, and
identify and analyze user status information and optimize the proposal information based on the user status information.

### Supplementary 2

The system according to supplementary 1,
wherein the processor is configured to
verify the consistency of the energy utilization information and correct anomalous values.

### Supplementary 3

The system according to supplementary 1,
wherein the processor is configured to
obtain information from the user after presenting the proposal information and reconfigure the proposal information using the generative information processing model and the user status analysis result.

### Application Example 2

### Supplementary 1

A system comprising a processor,
wherein the processor is configured to
continuously obtain energy usage state information and environmental emission information from a plurality of information acquisition devices,
store the received information and perform preprocessing such as integrity verification and abnormal value correction on the information,
analyze the preprocessed information and automatically generate proposal information using an analysis system,
obtain user emotion information and analyze said emotion information using an emotion analysis mechanism,
adjust and create presentation information based on analysis results and said emotion analysis results,
and present the created presentation information to a user.

### Supplementary 2

The system according to supplementary 1,
wherein the processor is configured to
perform integrity verification and abnormal value correction for environmental emission information and energy usage state information.

### Supplementary 3

The system according to supplementary 1,
wherein the processor is configured to
monitor operational status after the introduction of equipment based on the proposal information and obtain and provide feedback of evaluation information.

What is claimed is:

1. A system comprising a processor,
wherein the processor is configured to collect energy consumption data and CO2 emission data in real time by an IoT terminal,
store and preprocess the received data on a cloud server,
analyze the preprocessed data and generate a renewable energy investment proposal by a generative AI, and
generate an investment proposal report and provide said report to a user.

2. The system according to claim 1, wherein the processor is further configured to perform integrity verification of the energy consumption data and CO2 emission data, and to correct abnormal values.

3. The system according to claim 1, wherein the processor is further configured to monitor the post-installation performance of a renewable energy system and provide feedback.
